(19) United States
(12) Patent Application Publication
(10) Pub. No.: US 2007/0178254 A1
(43) Pub. Date: Aug. 2, 2007

(54) Electroconductive endless belt

(75) Inventor: Toshiaki Shimomura, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku (JP)

(21) Appl. No.: 11/655,211

(22) Filed: Jan. 19, 2007

(30) Foreign Application Priority Data
Jan. 20, 2006 (JP) 2006-12591
Dec. 25, 2006 (JP) 2006-347842

(51) Int. Cl. B41M 5/40

(52) U.S. Cl. 428/32.51

(57) ABSTRACT

An electroconductive endless belt is used for a tandem transfer/transport system. The system is configured to allow the electroconductive endless belt to hold a recording medium using electrostatic attraction, to drive the belt circularly by the action of a drive member so as to transport the recording medium held by the belt to four different image-forming members, and to transfer respective toner images provided on the image-forming members sequentially onto the recording medium. The electroconductive endless belt includes a thermoplastic resin as a base resin, an acrylic-modified polytetrafluoroethylene, and an electroconductive material.

### BACKGROUND OF THE INVENTION

1. Field of the Invention

The present invention relates to an electroconductive endless belt (hereinafter also simply referred to as “belt”) and an image-forming apparatus using the same. The endless belt is used when a toner image is transferred to a recording medium such as paper in an electrostatic recording process performed in an electrostatic recording apparatus or an electrophotographic apparatus such as a copying machine or a printer. The toner image is formed by supplying a developer onto the surface of an image-forming member such as a latent image bearing member bearing a latent image thereon.

2. Description of the Related Art

In an electrostatic recording process performed typically in a copying machine or a printer, printing is performed by the steps of uniformly electrifying the surface of a photosensitive member (latent image bearing member), forming an electrostatic latent image by projecting an optical image from an optical system onto this photosensitive member to diselectrify the area to which light is applied, then supplying toner to this electrostatic latent image to form a toner image by electrostatic adhesion of the toner, and transferring the toner image to a recording medium such as paper, transparent paper for overhead projector use, or photographic paper.

Also in a color printer or color copying machine, the printing is fundamentally performed in accordance with the process described above. However, a color printing process uses four color toners, magenta, yellow, cyan, and black for reproducing a color tone and further includes a step of overlapping the color toners at a predetermined ratio. Various methods have been proposed in order to execute this step.

Such methods include, for example, image-on-image development method as a first category. In this method, the above four color toners, magenta, yellow, cyan, and black, are sequentially supplied onto a photosensitive member so as to be superimposed for development in order to convert an electrostatic latent image into a visible color toner image, as in monochromatic printing. An apparatus according to this technique can have a relatively small size. However, it is very difficult to control the gradation, and as a result, a high quality image may not be obtained.

A second category is a tandem system using four photosensitive drums. In this method, four photosensitive drums are aligned; latent images on the drums are developed by respective color toners, magenta, yellow, cyan, and black to form four toner images of magenta, yellow, cyan, and black; the above respective toner images on the aligned photosensitive drums are then sequentially transferred to a recording medium, such as paper, for superimposing the images thereon and thereby reproducing a color image. By this method, superior images can be obtained; however, the apparatus becomes large and expensive, because the four drums each provided with an electrification mechanism and a development mechanism are aligned.

FIG. 2 shows an example of a printing portion of a tandem image-forming apparatus. Four printing units are provided for respective yellow Y, magenta M, cyan C, and black B toners. The printing units each include a photosensitive drum 1, an electrification roller 2, a developing roller 3, a developing blade 4, a toner supply roller 5, and a cleaning blade 6. The toners are sequentially transferred onto paper transported by a transfer/transport belt 10 which is circularly driven by a drive roller (drive member) 9, thereby forming a color image. Electrification and diselectrification of the transfer/transport belt 10 are performed by an electrification roller 7 and a diselectrification roller 8, respectively. The apparatus further includes an attraction roller (not shown) for electrification of paper to attract it by the belt. By the structure described above, the generation of ozone can be suppressed. The attraction roller transfers paper from a transport path onto the transfer/transport belt 10 and also fixes it thereon by electrostatic attraction. In addition, a transfer voltage is decreased after the transfer to decrease an attraction force between paper and the transfer/transport belt 10 so that paper can be separated from the transfer/transport belt only by means of self stripping.

Materials for the transfer/transport belt 10 include a resistive material and a dielectric material; however, each material has advantages and disadvantages. Since a resistive belt retains charges for a short period of time when being used for transfer operation of the tandem system, charge injection caused by the transfer is low, and even by continuous transfer operation of the four colors, the increase in voltage is relatively small. In addition, even when being used repeatedly for the following paper, the resistive belt releases charges, and electrical reset is not required. However, since the electrical resistance of the resistive belt varies with the change in environmental conditions, the transfer efficiently varies, and/or the thickness and the width of paper adversely affect the transfer performance.

In contrast, a dielectric belt is not so configured to release injected changes spontaneously and is thereby configured to electrically control injection and release of charges. However, attraction of paper is reliably performed, and highly precise paper transport can be performed, because the dielectric belt can stably retain charges. In addition, the dielectric constant less varies depending on temperature and humidity, and a relatively stable transfer process may be performed in various environments. As disadvantages, the increase in transfer voltage may be mentioned which is caused by accumulation of charges in the belt as the transfer is repeatedly performed.

A third category is a transfer drum method. In this method, a recording medium such as paper is wound around a transfer drum, and the drum is allowed to rotate four times. During this rotation, magenta, yellow, cyan, and black toners provided on photosensitive members are sequentially transferred on the medium at respective rotations of the drum, thereby reproducing a color image. According to this method, a relatively high quality image can be obtained. However, when a thick recording medium such as a postcard is used, it is difficult to wind the medium around the transfer drum, and the type of recording medium is disadvantageously limited.

In addition to the image-on-image development method, the tandem system, and the transfer drum method, an intermediate transfer system has been proposed as a method in which a high image quality can be obtained, the size of the apparatus is not particularly increased, and the type of recording medium is not particularly limited.

That is, according to this intermediate transfer system, an intermediate transfer member is provided which is composed of a belt and drums designed to temporarily retain toner images transferred from respective four photosensitive members, and four photosensitive members having a magenta toner image, a yellow toner image, a cyan toner image, and a black toner image are disposed around this intermediate transfer member. In the structure described above, the four color toner images are sequentially transferred onto the intermediate transfer member to form a color image thereon, and this color image is then transferred onto a recording medium such as paper. Accordingly, a high image quality can be obtained, because the gradation is adjusted by superimposing the four toner images. The size of the apparatus is not particularly increased, because the photosensitive members are not necessarily aligned, unlike the tandem system. The type of recording medium is therefore not specifically limited, because the recording medium is not required to be wound around the drum.

FIG. 3 shows an image-forming apparatus using an endless belt as the intermediate transfer member by way of example of an apparatus forming a color image in accordance with the intermediate transfer system.

The apparatus shown in FIG. 3 includes a drum-shaped photosensitive member 11 which is allowed to rotate in the direction shown by the arrow in FIG. 3. The photosensitive member 11 is electrified by a primary electrifier 12, a part of the member 11 exposed to an image exposure 13 is then diselectrified thereby, an electrostatic latent image corresponding to a first color component is subsequently formed on the photosensitive member 11, the electrostatic latent image is further developed by a developer 41 using a magenta toner M which is the first color, and as a result, the first-color magenta toner image is formed on the photosensitive member 11. Next, this toner image is transferred onto an intermediate transfer member 20 circularly driven by a drive roller (drive member) 30 while it is being in contact with the photosensitive member 11. In this case, the transfer from the photosensitive member 11 to the intermediate transfer member 20 is performed at a nip portion formed therebetween by a primary transfer bias applied from a power source 61 to the intermediate transfer member 20. After the first-color magenta toner image is transferred onto this intermediate transfer member 20, the surface of the photosensitive member 11 is cleaned by a cleaning device 14, and a first development and transfer operation of the photosensitive member 11 is complete. Subsequently, while the photosensitive member 11 is allowed to rotate three times, at the respective rotations, a second-color cyan toner image, a third-color yellow toner image, and a fourth-color black toner image are sequentially formed in that order on the photosensitive member 11 at the respective rotations by sequentially using developers 42 to 44. Thus, the four color images are superimposed on the intermediate transfer member 20 at the respective rotations, and a composite color toner image corresponding to an object color image is formed on the intermediate transfer member 20. In the apparatus shown in FIG. 3, at the respective rotations of the photosensitive member 11, the positions of the developers 41 to 44 are changed so that development of magenta toner M, cyan toner C, yellow toner Y, and black toner B are sequentially performed.

Next, a transfer roller 25 is then brought into contact with the intermediate transfer member 20 provided with the composite color toner image thereon, and to a nip portion therebetween, a recording medium 26 is supplied from a paper feed cassette 19. At the same time, a power source 29 applies a secondary transfer bias to the transfer roller 25, and the composite color toner image is transferred from the intermediate transfer member 20 onto the recording medium 26, followed by heating and fixing, thereby forming a final image. After the composite color toner image is transferred onto the recording medium 26, the intermediate transfer member 20 is processed by a cleaning device 35 so as to remove residual toners remaining on the surface and is then placed in a standby state for another image formation.

A tandem intermediate transfer system as a combination between the tandem system and the intermediate transfer system has also been proposed. FIG. 4 shows an image-forming apparatus in accordance with a tandem intermediate transfer system by way of example. In the method, color image formation is performed using an endless belt-shaped tandem intermediate transfer member.

In the apparatus shown in FIG. 4, a first, second, third, and fourth development portions 54a, 54b, 54c, and 54d are sequentially disposed along a tandem intermediate transfer member 50 for developing electrostatic latent images on photosensitive drums 52a, 52b, 52c, and 52d using yellow, magenta, cyan, and black toners, respectively, and this tandem intermediate transfer member 50 is circularly driven in the direction indicated by the arrow shown in FIG. 4, so that four color toner images formed on the photosensitive drums 52a to 52d of the respective development portions 54a to 54d are sequentially transferred on this tandem intermediate transfer member 50 to form a color toner image thereon. Subsequently, the formed toner image is transferred onto a recording medium 53 such as paper by transfer, thereby performing printout. Arrangement order of toners to use for the developing is not specifically limited and can be selected appropriately.

The apparatus shown in FIG. 4 further includes a drive roller or a tension roller 55 configured to circularly drive the tandem intermediate transfer member 50; a recording medium feed roller 56; a recording medium feed device 57; a fixing device 58 configured to fix an image on the recording medium typically by heating; and a power source device (voltage application means) 59 configured to apply a voltage to the tandem intermediate transfer member 50. The power source device 59 is configured to change the application direction of the voltage between the case where the toner image is transferred onto the tandem intermediate transfer member 50 from the photosensitive drums 52a to 52d and the case where the toner image is transferred from the tandem intermediate transfer member 50 to the recording medium 53.

Semiconductive resin film belts and fiber reinforced rubber belts have been primarily used as electroconductive endless belts for use, for example, as the transfer/transport belt 10, the intermediate transfer member 20, and the tandem intermediate transfer member 50. Of these, resin film belts include a semiconductive resin belt using a resin composition as disclosed in Japanese Unexamined Patent Application Publication No. 2004-061694. The resin composition herein includes a polyamide, a carbon black, a processing aid, and a lubricant. The processing aid includes fine particles of a fluorine-containing copolymer containing a tetrafluoroethylene component. The lubricant contains fine particles of a low molecular weight polytetrafluoroethylene. The present inventors and the assignee have proposed an electroconductive endless belt including a polymeric ionic conductive agent and a base material selected from, for example, a thermoplastic polyamide (PA), an acrylonitrile-butadiene-styrene (ABS) resin, and a thermoplastic polyacetal (POM) in Japanese Unexamined Patent Application Publication No. 2003-091177; and an electroconductive endless belt including a polymeric ionic conductive agent and a base material containing a fluorocarbon polymer and a specific thermoplastic resin selected from, for example, thermoplastic polyamide (PA), an acrylonitrile-butadiene-styrene (ABS) resin, and a thermoplastic polyacetal (POM) in Japanese Unexamined Patent Application Publication No. 2004-272210. They have also proposed a belt including an electroconductive material, and a base material containing a thermoplastic poly(alkylene naphthalate) and another thermoplastic resin having an ester bond and having a specific melt flow rate (MFR) in a specific weight ratio in Japanese Unexamined Patent Application Publication No. 2005-266760 (corresponding to Japanese Patent Application No. 2004-300533).

Of these image-forming apparatuses, those using the intermediate transfer system should exhibit a high transfer efficiency in transfer of images, because image transfer is conducted after holding toners on the intermediate transfer member 20. However, repetitive use of the apparatuses causes residual toners on the belt due typically to cleaning failure. The residual toners adhere to the surface of the belt upon long-term repetitive use and thereby invites image failures such as partially dense, irregular images. These problems may occur in apparatuses using the tandem transfer system, because toners scattered upon registration or transfer failure such as paper jamming remain on the belt. In addition, electroconductive endless belts should have satisfactory electric properties and exhibit high toner transfer efficiencies.

### SUMMARY OF THE INVENTION

Accordingly, it is desirable to provide an electroconductive endless belt which is resistant to adhesion of toners in long-term repetitive use of belt and can highly efficiently transfer toners upon output of images. It is also desirable to provide an image-forming apparatus using the endless belt.

After intensive investigations, the present inventors have found that a belt containing a thermoplastic resin as a base resin may become more resistant to adhesion of toners and more efficiently transfer images upon output of images by incorporating an acrylic-modified polytetrafluoroethylene (acrylic-modified PTFE) thereto.

According to an embodiment of the present invention, there is provided an electroconductive endless belt for use as an intermediate transfer member, which intermediate transfer member is disposed between an image-forming member and a recording medium and is configured to be circularly driven by a drive member, to temporarily hold toner images transferred from the surface of the image-forming member, and to transfer the toner images onto the recording medium. The electroconductive endless belt includes a thermoplastic resin as a base resin, an acrylic-modified polytetrafluoroethylene, and an electroconductive material.

According to another embodiment of the present invention, there is provided an electroconductive endless belt for a tandem transfer/transport system, which system is configured to allow the electroconductive endless belt to hold a recording medium using electrostatic attraction, to drive the belt circularly by the action of a drive member so as to transport the recording medium held by the belt to four different image-forming members, and to transfer respective toner images provided on the image-forming members sequentially onto the recording medium. The electroconductive endless belt includes a thermoplastic resin as a base resin, an acrylic-modified polytetrafluoroethylene, and an electroconductive material.

There is also provide, according to yet another embodiment of the present invention, an electroconductive endless belt for use as a tandem intermediate transfer member, which tandem intermediate transfer member is disposed between four different image-forming members and a recording medium and is configured to be circularly driven by a drive member, to temporarily hold toner images sequentially transferred from the image-forming members, and to transfer the toner images onto the recording medium. The electroconductive endless belt includes a thermoplastic resin as a base resin, an acrylic-modified polytetrafluoroethylene, and an electroconductive material.

The thermoplastic resin preferably includes at least one selected from the group consisting of (a) a thermoplastic polyamide, (b) an acrylonitrile-butadiene-styrene resin, (c) a thermoplastic polyacetal, (d) a polymer alloy or a polymer blend containing at least two of the resins (a) to (c), and (e) a polymer alloy or a polymer blend containing at least one of the resins (a) to (c) and another thermoplastic resin, and the electroconductive material preferably contains a polymeric ionic conductive agent.

The thermoplastic resin preferably includes both a thermoplastic polyester resin and a thermoplastic polyester elastomer. The thermoplastic resin preferably includes a thermoplastic poly(alkylene naphthalate) in combination with another thermoplastic resin having an ester bond than the thermoplastic poly(alkylene naphthalate). In this case the thermoplastic resin having an ester bond preferably has a melt flow rate (MFR) at 270° C. of 3 to 80 grams/10 minutes. The weight ratio of the thermoplastic poly(alkylene naphthalate) to the thermoplastic resin having an ester bond is preferably within a range of 95:5 to 55:45. The electroconductive material preferably includes a carbon black.

According to still another embodiment of the present invention, there is provided an image-forming apparatus using an electroconductive endless belt according to an embodiment of the present invention.

According to an embodiment of the present invention, an electroconductive endless belt according to an embodiment of the present invention includes a thermoplastic resin as a base resin and an acrylic-modified polytetrafluoroethylene. The acrylic-modified polytetrafluoroethylene is more dispersed in the thermoplastic resin than a non-modified polytetrafluoroethylene and thereby exhibits its anti-fouling activity without adversely affecting surface properties of the belt. The belt can have satisfactorily high toner-releasing by incorporating fluorine thereto and the belt may be more resistant to toner adhesion and may carry out image transfer more efficiently. There is provided an electroconductive endless belt and an image-forming apparatus which are resistant to adhesion of toners in long-term repetitive use of belt and can highly efficiently transfer toners upon output of images.

### BRIEF DESCRIPTION OF THE DRAWINGS

FIGS. 1A and 1B are cross-sectional views each showing an electroconductive endless belt in the width direction according to an embodiment of the present invention;

FIG. 2 is a schematic view showing a tandem image-forming apparatus using a transfer/transport belt, as an image-forming apparatus according to an embodiment of the present invention;

FIG. 3 is a schematic view showing an intermediate transfer apparatus using an intermediate transfer member, as an image-forming apparatus according to another embodiment of the present invention; and

FIG. 4 is a schematic view showing a tandem intermediate transfer apparatus using a tandem intermediate transfer member, as an image-forming apparatus according to yet another embodiment of the present invention.

### DESCRIPTION OF THE PREFERRED EMBODIMENTS

Electroconductive endless belts are generally roughly classified as two types, one having a joint portion and the other having no joint portion (so-called seamless belt), and both of them may be used herein. However, preferable is a seamless belt. As described above, an electroconductive endless belt according to an embodiment of the present invention is an endless belt which can be used as transfer members typically of the tandem system, the intermediate transfer system, and the tandem intermediate transfer system.

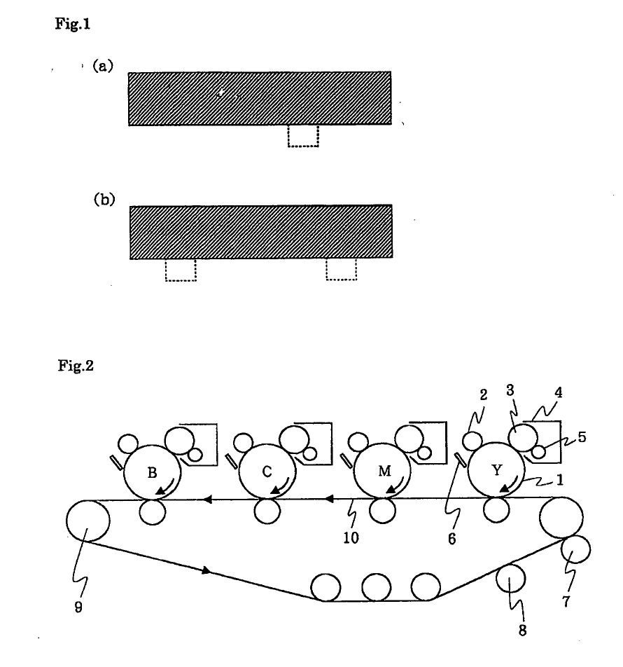

For example, when an electroconductive endless belt according to an embodiment of the present invention is a transfer/transport belt 10 shown in FIG. 2, the electroconductive endless belt is driven by a drive member such as the drive roller 9, and the toners are sequentially transferred onto the recording medium which is transported by the endless belt, thereby forming a color image.

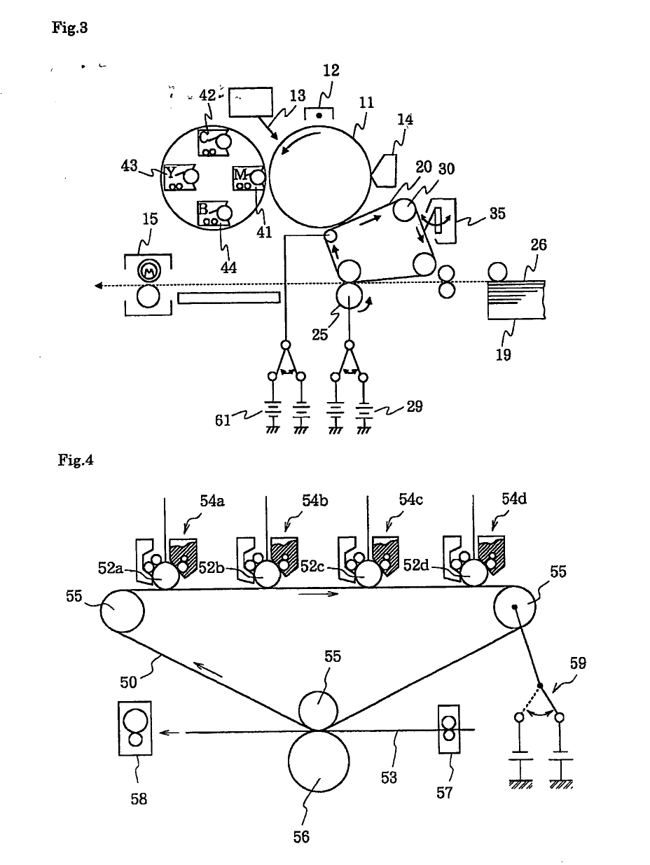

When an electroconductive endless belt according to an embodiment of the present invention is an intermediate transfer member 20 shown in FIG. 3, the electroconductive endless belt is circularly driven by a drive member such as the drive roller 30 and is disposed between the photosensitive drum (latent bearing member) 11 and the recording medium 26 such as paper, and the toner image formed on the surface of the photosensitive drum 11 is transferred onto the electroconductive endless belt 20 and is then temporarily held thereby, followed by transfer of the toner image onto the recording medium 26. As described above, the apparatus shown in FIG. 3 is an apparatus performing color printing in accordance with the intermediate transfer system.

When an electroconductive endless belt according to an embodiment of the present invention is a tandem intermediate transfer member 50 shown in FIG. 4, the electroconductive endless belt is disposed between the development portions 54a to 54d having the photosensitive drums 52a to 52d, respectively, and the recording medium 53 such as paper, and is circularly driven by a drive member such as the drive rollers 55, and the four color toner images formed on the surface of the photosensitive drums 52a to 52d are transferred onto the electroconductive endless belt 50 and are then temporarily held thereby, followed by transfer of the toner images onto the recording medium 53, thereby forming a color image.

An electroconductive endless belt according to an embodiment of the present invention includes a thermoplastic resin as a base resin, and an acrylic-modified polytetrafluoroethylene and an electroconductive material. The acrylic-modified polytetrafluoroethylene is dispersed in the thermoplastic resin as fine fibrils and thereby exhibits its anti-fouling activity without adversely affecting surface properties of the belt, and the belt may be more resistant to toner adhesion and may carry out image transfer more efficiently. In addition, a resin composition including these components exhibits an increased viscosity when melted to as to improve resistance to drawdown during molding. When a belt according to an embodiment of the present invention is applied to an intermediate transfer system or a tandem intermediate transfer system, the belt may be more resistant to toner adhesion and carry out image transfer more efficiently during long-term, repetitive image output. When it is applied to a tandem transfer system, the belt may be more resistant to toner adhesion during long-term, repetitive image output.

Specific examples of such acrylic-modified polytetrafluoroethylenes include tetrafluoroethylene polymers modified with alkyl methacrylate-alkyl acrylate copolymers. A preferred example thereof is a commercially available product under the trade name of METABLEN A-3000 from Mitsubishi Rayon Co., Ltd. The amount of an acrylic-modified polytetrafluoroethylene is generally about 0.01 to about 5 parts by weight and preferably about 0.05 to about 2 parts by weight, to 100 parts by weight of the thermoplastic resin component. An acrylic-modified polytetrafluoroethylene added in an excessively large amount may cause surface roughness and excessively increased viscosity.

Thermoplastic resins for use herein are not specifically limited and can be selected appropriately from among thermoplastic resins for use as base materials for belts. Thermoplastic resins are preferably at least one selected from (a) a thermoplastic polyamide resin (PA), (b) an acrylonitrile-butadiene-styrene resin (ABS), (c) a thermoplastic polyacetal (POM), (d) a polymer alloy or a polymer blend containing at least two of the resins (a) to (c), and (e) a polymer alloy or a polymer blend containing at least one of the resins (a) to (c) and another thermoplastic resin than the resins (a) to (c). Of such other thermoplastic resins, a thermoplastic elastomer is preferred. In this case, a polymeric ionic conductive agent is preferably used as an electroconductive material in combination.

The thermoplastic polyamide (a) for use herein is one of resins having the longest history and is used as a material having superior abrasion resistance besides superior strength and impact resistance, and in addition, the thermoplastic polyamide (PA) is easily commercially available. Thermoplastic polyamides include various types, of which preferred are nylon 12 (hereinafter referred to as “PA 12”) which may be available as products from Toray Industries, Inc. under the trade name of Rilsan AESNO TL, from Daicel Huels Ltd. under the trade names of Diamide L2101 and Diamide L1940, and products from Ube Industries Ltd. under the trade name of 3024U. PA 12 has superior dimensional stability capable of withstanding the change in circumstances as compared to that of the other PAs. PA 6 is also preferably used. When the thermoplastic polyamides described above are used as a base material for an electroconductive endless belt, the resulting electroconductive endless belt can have small variation in electrical resistance and superior strength, in particular, superior folding endurance. PA 12 for use herein may have a number-average molecular weight of preferably 7,000 to 100,000 and more preferably 13,000 to 40,000.

Preferable polymer alloys formed from the PA described above and a thermoplastic elastomer include, for example, a block copolymer alloy formed from PA 12 and a thermoplastic polyether. By this copolymer alloy, an effect of improving low-temperature properties can also be obtained in addition to the dimensional stability. The polymer alloy of PA 12 and a thermoplastic polyester is also commercially available, for example, from Daicel Huels Ltd. under the trade name of Diamide X4442.

Thermoplastic elastomers suitably used for the polymer blend with PA include polymers each having a Young's modulus of 98,000 N/cm² or less and more preferably in the range of 980 to 49,000 N/cm². They include polyester, polyamide, polyether, polyolefin, polyurethane, styrene, acrylic, and polydiene elastomers. When a thermoplastic elastomer is used for the polymer blend, the resulting belt may have an increased number of folding actions to failure and improved durability against cracking. A polymer blend of PA 12 with a thermoplastic elastomer is also commercially available, for example, from Daicel Huels Ltd. under the trade name of Diamide E1947.

When a polymer alloy or a polymer blend between PA and a thermoplastic elastomer is used and PA is a PA 12, the weight ratio between the two components is preferably such that 100 parts by weight or less of a thermoplastic elastomer is used per 100 parts by weight of PA 12.

The acrylonitrile-butadiene-styrene (ABS) resin (b) is a thermoplastic resin having superior impact resistance and dimensional stability and is easily commercially available. Representative examples thereof are products available from Daicel Polymer Ltd. under the trade names of Cevian V320 and Cevian V680. When the ABS resin described above is used as a base material (base resin), the resulting electroconductive endless belt may have small variation in electrical resistance, superior strength, in particular, superior folding endurance, and high dimensional stability.

Preferable polymer alloys and polymer blends of the ABS resin described above include polymer alloys with a thermoplastic poly(butylene terephthalate) (PBT), a thermoplastic polycarbonate (PC), and a thermoplastic polyamide (PA). The above polymer alloys and polymer blends of the ABS resin with thermoplastic resins are commercially available, for example, as polymer alloys from Daicel Polymer Ltd. under the trade names of Novalloy B1500 and B1700 (PBT/ABS resin), Novalloy S1100 (PC/ABS resin), and Novalloy A1500 (PA 6/ABS resin). By those polymer alloys, improvement in heat resistance, chemical resistance, and toughness (PBT/ABS resin), improvement in heat resistance, impact resistance, and toughness (PC/ABS resin), and improvement in impact resistance and chemical resistance (PA 6/ABS resin) can be obtained.

The thermoplastic polyacetal (POM) (c) may be in the form of a homopolymer or a copolymer; however, a copolymer is preferable in terms of heat stability. POMs have well balanced properties such as strength, abrasion resistance, dimensional stability, and moldability and are categorized as engineering plastics which are widely used typically for plastic gears and are easily commercially available. POMs are commercially available, for example, as products from Asahi Kasei Corporation under the trade name of Tenac 2010, and products from Polyplastics Co., Ltd. under the trade name of Duracon M25-34. When a POM is used as a base material for an electroconductive endless belt, the resulting electroconductive endless belt can have small variation in electrical resistance, superior strength, in particular, superior folding endurance and creep resistance, and high dimensional stability.

Preferable polymer alloys containing the POMs include, for example, a polymer alloy with a thermoplastic polyurethane. By this polymer alloy, superior impact resistance can also be obtained in addition to the above superior properties. The polymer alloy of POM with a thermoplastic polyurethane is commercially available, for example, from Asahi Kasei Corporation under the trade name of Tenac 4012.

As a thermoplastic elastomer preferably used together with POM for forming a polymer blend, the same materials as mentioned for the case of the PA may also be used. Also in this case, by the blending effect with the thermoplastic elastomer, the number of folding actions to failure is increased, and durability against cracking can be improved.

When a belt according to an embodiment of the present invention mainly includes a thermoplastic resin selected from the group consisting of the resins (a) to (e), the belt preferably further includes a fluorocarbon polymer. When the fluorocarbon polymer is blended and compounded with the above polymer materials, the belt can have satisfactorily high toner-releasing properties.

The fluorocarbon polymer is preferably a resin having a low melting point typically of 250° C. or less and particularly 240° C. or less. Examples thereof are poly(vinylidene fluoride)s (PVdFs), polychlorotrifluoroethylenes (PCTFEs), copolymers of chlorotrifluoroethylene and ethylene (ECTFEs), copolymers of vinylidene fluoride (VDF) and tetrafluoroethylene (TFE), and terpolymers (THVs) of tetrafluoroethylene, hexafluoropropylene (HFP), and vinylidene fluoride. These fluorocarbon polymers are easily commercially available. Copolymers of vinylidene fluoride and tetrafluoroethylene are available, for example, as products from Daikin Industries, Ltd. under the trade name of Neoflon VT100, and THVs are available, for example, as products from Dyneon LLC through Sumitomo 3M Ltd. under the trade names of Dyneon THV 220G and Dyneon THV 500G.

The fluorocarbon polymers may be used alone or in combination. Among those resins, THVs are particularly preferable, because they have significantly low melting points of, for example, about 120° C. to about 200° C., and when compounded together with another material, they are easily melted to exhibit the blending effect. THVs are resin materials having a low melting point and including three types of monomers, that is, tetrafluoroethylene, hexafluoropropylene, and vinylidene fluoride. They have superior properties such as machinability, solubility, cross-linking property, flexibility, adhesion property, and transparency, in addition to the properties of common fluorocarbon polymers, such as heat resistance, chemical resistance, weather resistance, non-sticking property, and fire retardant properties. THVs may have varying melting points by adjusting the ratio among the above monomers.

The amount of the fluorocarbon polymer is preferably about 0.1 to about 50 percent by weight and more preferably about 1 to about 20 percent by weight relative to the total amount of the base material (thermoplastic resin component). When the amount of the fluorocarbon polymer is too large, the volume resistivity of the belt is adversely affected. In contrast, when the amount is in the range as described above, while the volume resistivity is not substantially changed, the toner-releasing properties and fusion resistance can be preferably obtained.

The thermoplastic resin as a base resin preferably includes a thermoplastic polyester resin in combination with a thermoplastic polyester elastomer. Thermoplastic polyester resins for use herein are not specifically limited. Examples thereof are a thermoplastic poly(alkylene naphthalate) and a thermoplastic poly(alkylene terephthalate). The thermoplastic poly(alkylene naphthalate) include a thermoplastic polyethylene naphthalate) (PEN) and a thermoplastic poly(butylene naphthalate) (PBN). The thermoplastic poly(alkylene terephthalate) include a thermoplastic poly(ethylene terephthalate) (PET), glycol-modified poly(ethylene terephthalate) (PET) and a thermoplastic poly(butylene terephthalate) (PBT). Thermoplastic polyester resins may be used alone or in combination.

Thermoplastic polyester elastomers for use herein are not specifically limited. Examples thereof are elastomers having polyester-polyester seguments and elastomers having polyester-polyether seguments. The elastomers having polyester-polyester seguments include polyester resins as hard and soft segments. The elastomers having polyester-polyether seguments include polyester resins as hard segments and polyether resins as soft segments. The polyester hard seguments for use herein are not specifically limited and preferably include PBT or PBN as a base component. Thermoplastic polyester elastomers may be used alone or in combination.

In the present invention, the thermoplastic polyester resin and the thermoplastic polyester elastomer may be mixed in a ratio depending on a use appropriately.

The thermoplastic resin as a base resin preferably includes a thermoplastic poly(alkylene naphthalate) in combination with another thermoplastic resin having an ester bond. In this case, a carbon black is preferably used as the electroconductive material.

Such a thermoplastic poly(alkylene naphthalate) is an engineering plastic that is excellent in impact resistance, dimensional stability, and weather resistance and is satisfactory in elastic recovery properties. It is easily commercially available. Examples of the thermoplastic poly(alkylene naphthalate) include a thermoplastic poly(ethylene naphthalate) (PEN) and a thermoplastic poly(butylene naphthalate) (PBN). Each of these may also be preferably used in combination.

Thermoplastic resins having an ester bond for use herein have a melt flow rate (MFR) at 270° C. of 3 to 80 grams/10 minutes, and preferably have a melt flow rate (MFR) at 270° C. of 5 to 40 grams/10 minutes. If a thermoplastic resin has a melt flow rate (MFR) at 270° C. higher than the above range, the resulting belt may have insufficient folding endurance. If a thermoplastic resin has a melt flow rate (MFR) at 270° C. lower than the range, the resin may have insufficient compatibility. In these cases the advantages according to an embodiment of the present invention are adversely affected. A melt flow rate at a temperature of 270° C. is taken as the reference herein. This is because melting and kneading of components and molding them into a belt may be carried out at temperatures of around 270° C. in consideration of the melting point of a thermoplastic poly(alkylene naphthalate), if used as a base resin of a belt according to an embodiment of the present invention. The thermoplastic resin having an ester bond can be, for example, a thermoplastic poly(alkylene terephthalate). Specific examples thereof include thermoplastic poly(ethylene terephthalate)s (PETs) each having a melt flow rate (MFR) at 270° C. of about 3 to about 45 grams/10 minutes, and thermoplastic poly(butylene terephthalate)s (PBTs) each having a melt flow rate (MFR) at 270° C. of about 25 to about 80 grams/10 minutes.

The weight ratio of the thermoplastic poly(alkylene naphthalate) to the thermoplastic resin having an ester bond is generally within the range of about 95:5 to about 55:45, and preferably within the range of about 80:20 to about 60:40. If the proportion of the thermoplastic resin having an ester bond is smaller than the above range, the belt may have insufficient folding endurance. If it exceeds the above range, the belt may have poor surface properties. In these cases the advantages according to an embodiment of the present invention are adversely affected.

Electroconductive materials can be used in the above-mentioned preferred combinations, respectively. Of these, the polymeric ionic conductive agent includes, but is not limited to, materials disclosed in Japanese Unexamined Patent Application Publication Nos. 9-227717, 10-120924, and 2000-327922.

Specific examples thereof include mixtures containing (A) an organic polymer material, (B) an ionic conducting polymer or copolymer, and (C) an inorganic or low molecular weight organic salt. The component (A) can be, for example, a polyacrylate, polymethacrylate, polyacrylonitrile, poly(vinyl alcohol), poly(vinyl acetate), polyamide, polyurethane, or polyester. The component (B) can be, for example, an oligoethoxylated acrylate or methacrylate, styrene oligoethoxylated at the aromatic ring, poly(ether urethane), poly(ether urea), poly(ether amide), poly(ether ester amide) or poly(ether ester). The component (C) can be a salt of an inorganic or low molecular weight organic protic acid with an alkali metal, alkaline earth metal, zinc or ammonium. Preferable salts include, for example, LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂, and Ca(CF₃SO₃)₂.

Among them, the component (B) is preferably a polymeric ionic conductive agent containing a poly(ether amide) component or a poly(ether ester amide) component. In this case, the mixture preferably contains an ionic conductive agent component having a low molecular weight as the component (C). The poly(ether amide) component and the poly(ether ester amide) component preferably contain (CH₂—CH₂—O) as a polyether moiety and nylon 12 (PA12) or nylon 6 (PA6) as a polyamide moiety. Preferred is a polymeric ionic conductive agent containing the above components as the component (B), and a material containing NaClO₄, which is an ionic conductive agent component having a low molecular weight for use as the component (C).

Such polymeric ionic conductive agents are easily commercially available as, for example, products from Ciba Specialty Chemicals Inc. under the trade names of Irgastat® P18 and Irgastat® P22; and products from Sanyo Chemical Industries, Ltd. under the trade names of Pelestat NC6321, Pelestat 230, and Pelestat 300. If a belt includes a polymeric ionic conductive agent as an electroconductive material, the belt may further includes a compatibilizer so as to increase the compatibility (miscibility) between the base resin and the polymeric ionic conductive agent.

The amount of the polymeric ionic conductive agent is preferably 1 to 500 parts by weight and more preferably 10 to 400 parts by weight relative to 100 parts by weight of the resin component (base resin). By satisfying this, the volume resistivity of the belt can be preferably adjusted in the range of 10⁷ to 10¹⁴ Ω·cm and more preferably in the range of 10⁸ to 10^{12.5} Ω·cm. When the amount of the polymeric ionic conductive agent is less than 1 part by weight, the resistivity level described above may not be obtained. In contrast, when the amount is more than 500 parts by weight, properties such as the folding endurance may be adversely affected.

The carbon black for use herein includes, for example, electroconductive carbon materials such as Ketjenblack and acetylene black; carbon materials for rubber, such as SAF, ISAF, HAF, FEF, GPF, SRF, FT, and MT; oxidized carbon materials for color ink; and thermally decomposed carbon materials. The amount of a carbon black is preferably about 5 to about 30 parts by weight, to 100 parts by weight of the resin component (base resin). By satisfying this, the belt may have an adjusted volume resistivity of about 10² Ω·cm to about 10¹³ Ω·cm.

By adding another electroconductive material as a functional component to the composition to constitute a belt, the conductivity may be imparted or adjusted in an auxiliary manner. Such additional electroconductive material include, but are not limited to, cationic surfactants including quaternary ammonium salts such as perchlorates, chlorates, tetrafluoroborates, sulfates, ethosulfates, and halogenated benzyl salts (salts typically of benzyl bromide and benzyl chloride) of lauryltrimethylammonium, stearyltrimethylammonium, octadecyltrimethylammonium, dodecyltrimethylammonium, hexadecyltrimethylammonium, or modified fatty acid-dimethylethylammonium; anionic surfactants including aliphatic sulfonates, higher alcohol sulfates, sulfates of higher alcohol-ethylene oxide adduct, and higher alcohol phosphates; amphoteric surfactants including various betaines; anti-static agents including nonionic anti-static agents such as higher alcohol ethylene oxides, polyethylene glycol fatty acid esters, and polyhydric alcohol fatty acid esters; metal salts of Group I of the Periodic Table of Elements, such as LiCF₂SO₂, NaClO₄, LiBF₄, and NaCl; metal salts of Group II of the Periodic Table of Elements, such as Ca(ClO₄)₂; and derivatives of these anti-static agents further having at least one group (such as a hydroxyl group, a carboxyl group, or a primary or secondary amine group) containing an active hydrogen reactive with isocyanate. The additional electroconductive materials further include, for example, ionic conductive agents including complexes of the above electroconductive materials with polyhydric alcohols (such as 1,4-butanediol, ethylene glycol, polyethylene glycol, and propylene glycol) or its derivatives, and complexes of the above electroconductive materials typically with ethylene glycol monomethyl ether and ethylene glycol monoethyl ether; graphite materials such as natural graphite and artificial graphite; metals and metal oxides, such as tin oxide, titanium oxide, zinc oxide, nickel, and copper; and electroconductive polymers such as polyanilines, polypyrroles, and polyacetylenes.

Each of such additional electroconductive materials can be used alone or in combination as appropriate. For example, an electron conductive agent and an ionic conductive agent can be used in combination, and this combination contributes to stabilization of electroconductivity against variations in voltage and environment. The amount of such additional electroconductive materials is preferably in the range of about 0.01 to about 30 parts by weight and is more preferably in the range of about 0.1 to about 20 parts by weight, relative to 100 parts by weight of the resin component (base resin).

Other functional components may also be added to the components described above, as long as the advantages according to an embodiment of the present invention are not adversely affected. The functional components include, for example, various fillers, coupling agents, antioxidants, lubricants, surface finishing agents, pigments, ultraviolet absorbers, anti-static agents, dispersants, neutralizing agents, foaming agents, and cross-linking agents. In addition, a belt may be colored by adding a colorant.

The thickness of an electroconductive endless belt according to an embodiment of the present invention is optionally determined in accordance with the structure as a transfer/transport belt or an intermediate transfer member; however, the thickness is preferably set in the range of about 50 to about 200 μm. The electroconductive endless belt has a surface roughness in terms of ten-point-average height Rz as determined in Japanese Industrial Standards (JIS) of preferably about 10 μm or less, more preferably about 6 μm or less, and particularly preferably about 3 μm or less.

An electroconductive endless belt according to an embodiment of the present invention may have an engage portion, as indicated by chain lines in FIGS. 1A and 1B, at the side to be brought into contact with the drive member such as the drive roller 9 of the image-forming apparatus in FIG. 2 or the drive roller 30 in FIG. 3 so as to engage with an engage portion (not shown) provided for the drive member. When being driven while the engage portion of the belt engages with the engage portion of the drive member, the electroconductive endless belt is prevented from being shifted in the width direction.

In this case, although not being particularly limited, the engage portion preferably has a continuous protrusion shape along the circumferential direction (rotation direction) of the belt (FIGS. 1A and 1B) so as to engage with a groove formed in the drive member such as the drive roller along the circumferential direction.

In FIG. 1A, one continuous protrusion is shown as the engage portion by way of example; however, as the engage portion, many protrusions may be aligned along the circumferential direction (rotation direction) of the belt, at least two protrusions may be provided (FIG. 1B), or one protrusion may be provided at the central portion in the width direction of the belt. Furthermore, instead of the protrusion for use as the engage portion shown in FIGS. 1A and 1B, a groove may be provided in the belt along the circumferential direction (rotation direction) thereof so as to engage with a protrusion formed on the drive member such as the drive roller along the circumferential direction thereof.

An image-forming apparatus according to an embodiment of the present invention using the electroconductive endless belt can for example be, but is not limited to, a tandem apparatus shown in FIG. 2, an intermediate transfer apparatus shown in FIG. 3, and a tandem intermediate transfer apparatus shown in FIG. 4. In the apparatus shown in FIG. 3, a voltage may be optionally applied from the power source 61 to the drive roller or drive gear configured to drive the intermediate transfer member 20 as an electroconductive endless belt according to an embodiment of the present invention. In this case, the voltage application way may be optionally selected, for example, direct current is applied alone or is superimposed on alternating current.

A method for manufacturing an electroconductive endless belt according to an embodiment of the present invention is not particularly limited, and for example, the electroconductive endless belt may be manufactured by compounding resin components of the base material with functional components such as an electroconductive material typically by a dual-screw kneader, followed by extrusion of the resulting kneaded product using a ring die. In addition, powder coating typically by electrostatic coating, dipping, and centrifugal casting may also be preferably used.

### EXAMPLES

The present invention will be illustrated in further detail with reference to several examples below, which by no means limit the scope of the present invention.

### Examples 1 to 13 and Comparative Examples 1 to 7

Electroconductive endless belts according to Examples 1 to 13 and Comparative Examples 1 to 7, having the compositions shown in Tables 1 to 3 below were prepared. More specifically, components of individual layers were melted and kneaded using a dual-screw kneader, and the resulting kneaded products were extruded and molded using a ring die and thereby yielded electroconductive endless belts each having an inner diameter of 220 mm, a thickness of 100 μm, and a width of 250 mm. The properties of the prepared belts were evaluated according to the following procedures. The results are also shown in Tables 1 to 3.

<Measurement of Volume Resistivity>

The volume resistivity was measured at a measurement voltage of 100 V, a temperature of 23° C., and relative humidity of 50% using a sample chamber R12704A connected to a resistance meter R8340A (Advantest Corporation). Furthermore, the volume resistivity was measured under the same conditions by using the same device as above, except that the measurement voltage was set to 1,000 V, and the number of digits of the voltage dependence was calculated according to the following equation:
(Number of Digits)=log(R_{100V}/R_{1000V})
wherein R_{100V} and R_{1000V} represent the volume resistivity (Ω·cm) determined at 100 V and that determined at 1,000 V, respectively.
<Image Quality>

The prepared belts were mounted for an intermediate transfer image-forming apparatus shown in FIG. 3 using an intermediate transfer belt, and an endurance test was performed in which transfer was repeatedly performed for 10,000 sheets of A-4 sized paper. Based on the results of this endurance test, the image quality, toner deposition in the endurance test, and stain resistance were evaluated.

<Transfer Efficiency>

The transfer efficiency was determined according to the following steps (1) to (3).

(1) The weight of belt (A1) and that of paper (B1) were measured before transfer step (2).

(2) The above-prepared belts were mounted for an intermediate transfer image-forming apparatus as an intermediate transfer belt shown in FIG. 3, and a series of transfer procedures (image output) was conducted, and the weight of belt (A2) and that of paper (B2) were measured.

(3) The transfer efficiency was determined by calculation according to the following equation:
Transfer efficiency(%)=(B2−B1)/[(B2−B1)+(A2−A1)]×100

TABLE 1

| | | Example | Example | Example | Example | Example | Example | Example |
|---|---|---|---|---|---|---|---|---|
| | | 1 | 2 | 3 | 4 | 5 | 6 | 7 |
| Belt composition | PA12*¹ | 70 | 70 | 70 | 60 | 60 | 60 | — |
| | ABS*² | 30 | 30 | 30 | 30 | 30 | 30 | — |
| | POM*³ | — | — | — | — | — | — | 95 |
| | Polymeric | 35 | 35 | 35 | 35 | 35 | 35 | 25 |
| | ionic | | | | | | | |
| | conductive | | | | | | | |
| | agent*⁴ | | | | | | | |
| | Colorant*⁵ | 5 | 5 | 5 | 5 | 5 | 5 | — |
| | Fluorocarbon | — | — | — | 10 | 10 | 10 | — |
| | polymer (A)*⁶ | | | | | | | |
| | Fluorocarbon | — | — | — | — | — | — | — |
| | polymer (B)*⁷ | | | | | | | |
| | Fluorocarbon | — | — | — | — | — | — | — |
| | polymer (C)*⁸ | | | | | | | |
| | Fluorocarbon | — | — | — | — | — | — | 5 |
| | polymer (D)*⁹ | | | | | | | |
| | PTFE | 0.3 | 0.7 | 2.7 | 0.3 | 0.7 | 2.7 | 0.3 |
| | Acrylic- | | | | | | | |
| | modified | | | | | | | |
| | PTFE*¹⁰ | | | | | | | |
| | PTFE*¹¹ | — | — | — | — | — | — | — |
| | Molding | 215 | 215 | 215 | 220 | 220 | 220 | 190 |
| | temperature(° C.) | | | | | | | |
| | Volume | 11.3 | 11.3 | 11.3 | 10.9 | 10.8 | 10.8 | 12.1 |
| | resistivity | | | | | | | |
| | log R (100 V) | | | | | | | |
| | (Ω • cm) | | | | | | | |
| | Voltage | 0.6 | 0.6 | 0.6 | 0.9 | 0.8 | 0.9 | 0.6 |
| | dependency | | | | | | | |
| | (100-1000V) | | | | | | | |
| | (digits) | | | | | | | |
| | Image quality | Smooth | Smooth | Smooth | Smooth | Smooth | Smooth | Smooth |
| | | and | and | and | and | and | and | and |
| | | Good | Good | Good | Good | Good | Good | Good |
| | Toner | Slight | Slight | Slight | No | No | No | No |
| | deposition in | deposit- | deposit- | deposit- | deposit- | deposit- | deposit- | deposit- |
| | endurance test | ion | ion | ion | ion | ion | ion | ion |
| | (10000 sheets) | | | | | | | |
| | Stain | Good | Good | Good | Good | Good | Good | Good |
| | resistance | | | | | | | |
| | Transfer | 98 or | 98 or | 98 or | 98 or | 98 or | 98 or | 98 or |
| | efficiency (%) | more | more | more | more | more | more | more |

*¹PA12: 3024U (Ube Industries Ltd.)
*²ABS: Cevian V680 (Daicel Polymer Ltd.)
*³POM: Duracon M25-34 (Polyplastics Co., Ltd.)
*⁴Polymeric ionic conductive agent: Irgastat P18 (Ciba Specialty Chemicals Inc.)
*⁵Colorant: titanium oxide; ET500W (Ishihara Sangyo Kaisha, Ltd.)
*⁶Fluorocarbon polymer (A): PVdF; Neoflon VW410 (Daikin Industries, Ltd.)
*⁷Fluorocarbon polymer (B): PVdF, Neoflon VP825 (Daikin Industries, Ltd.)
*⁸Fluorocarbon polymer (C); PVdF-PTFE, Neoflon VT100 (Daikin Industries, Ltd.)
*⁹Fluorocarbon polymer (D): THV, Dyneon THV-500G (Sumitomo 3M Ltd.)
*¹⁰Acrylic-modified PTFE: Metablen A-3000 (Mitsubishi Rayon Co., Ltd.)
*¹¹PTFE: POLYFLON PTFE (low polymer) L2 (finely powdered PTFE) (Daikin Industries, Ltd.)

TABLE 2

| | | Example | Example | Example | Example | Example | Example |
|---|---|---|---|---|---|---|---|
| | | 8 | 9 | 10 | 11 | 12 | 13 |
| Belt composition | PA12*¹ | 60 | 60 | 60 | 60 | 60 | 60 |
| | ABS*² | 30 | 30 | 30 | 30 | 30 | 30 |
| | Polymeric | 35 | 35 | 35 | 35 | 35 | 35 |
| | ionic | | | | | | |
| | conductive | | | | | | |
| | agent*⁴ | | | | | | |
| | Colorant*⁵ | 5 | 5 | 5 | 5 | 5 | 5 |
| | Fluorocarbon | | | | | | |
| | polymer (A)*⁶ | — | — | — | — | — | — |
| | Fluorocarbon | 10 | 10 | 10 | — | — | — |
| | polymer (B)*⁷ | | | | | | |
| | Fluorocarbon | — | — | — | 10 | 10 | 10 |
| | polymer (C)*⁸ | | | | | | |
| | PTFE | | | | | | |
| | Acrylic- | 0.3 | 0.7 | 2.7 | 0.3 | 0.7 | 2.7 |
| | modified | | | | | | |
| | PTFE*¹⁰ | | | | | | |
| | PTFE*¹¹ | — | — | — | — | — | — |
| | Molding | 220 | 220 | 220 | 220 | 220 | 220 |
| | temperature (° C.) | | | | | | |
| | Volume | 10.2 | 10.2 | 10.1 | 10.8 | 10.8 | 10.7 |
| | resistivity | | | | | | |
| | log R (100 V) | | | | | | |
| | (Ω • cm) | | | | | | |
| | Voltage | 0.6 | 0.6 | 0.6 | 0.6 | 0.6 | 0.6 |
| | dependency | | | | | | |
| | (100-1000V) | | | | | | |
| | (digits) | | | | | | |
| | Image quality | Smooth | Smooth | Smooth | Smooth | Smooth | Smooth |
| | | and | and | and | and | and | and |
| | | Good | Good | Good | Good | Good | Good |
| | Toner | No | No | No | No | No | No |
| | deposition in | deposit- | deposit- | deposit- | deposit- | deposit- | deposit- |
| | endurance test | ion | ion | ion | ion | ion | ion |
| | (10000 sheets) | | | | | | |
| | Stain | Good | Good | Good | Good | Good | Good |
| | resistance | | | | | | |
| | Transfer | 98 or | 98 or | 98 or | 98 or | 98 or | 98 or |
| | efficiency (%) | more | more | more | more | more | more |

TABLE 3

| | | Com. Ex. | Com. Ex. | Com. Ex. | Com. Ex. | Com. Ex. | Com. Ex. | Com. Ex. |
|---|---|---|---|---|---|---|---|---|
| | | 1 | 2 | 3 | 4 | 5 | 6 | 7 |
| Belt composition | PA12*¹ | 70 | 60 | 60 | 60 | 60 | 60 | — |
| | ABS*² | 30 | 30 | 30 | 30 | 30 | 30 | — |
| | POM*³ | — | — | — | — | — | — | 95 |
| | Polymeric | 35 | 35 | 35 | 35 | 35 | 35 | 25 |
| | ionic | | | | | | | |
| | conductive | | | | | | | |
| | agent*⁴ | | | | | | | |
| | Colorant*⁵ | 5 | 5 | 5 | 5 | 5 | 5 | — |
| | Fluorocarbon | — | 10 | — | — | 10 | 10 | — |
| | polymer (A)*⁶ | | | | | | | |
| | Fluorocarbon | — | — | 10 | — | — | — | — |
| | polymer (B)*⁷ | | | | | | | |
| | Fluorocarbon | — | — | — | 10 | — | — | — |
| | polymer (C)*⁸ | — | — | — | 10 | — | — | — |
| | Fluorocarbon | — | — | — | — | — | — | 5 |
| | polymer (D)*⁹ | | | | | | | |
| | Acrylic- | — | — | — | — | — | — | — |
| | modified | | | | | | | |
| | PTFE*¹⁰ | | | | | | | |
| | PTFE*¹¹ | — | — | — | — | 0.5 | 2 | — |
| | Molding | 215 | 220 | 220 | 220 | 220 | 220 | 190 |
| | temperature (° C.) | | | | | | | |
| | Volume | 11.3 | 10.9 | 10.2 | 10.8 | 10.7 | 10.6 | 12.1 |
| | resistivity | | | | | | | |
| | log R (100 V) | | | | | | | |
| | (Ω • cm) | | | | | | | |
| | Voltage | 0.6 | 0.9 | 0.6 | 0.6 | 0.8 | 0.8 | 0.6 |
| | dependency | | | | | | | |
| | (100-1000V) | | | | | | | |
| | (digits) | | | | | | | |
| | Image quality | Smooth | Smooth | Smooth | Smooth | Smooth | Toner | Smooth |
| | | and | and | and | and | and | deposited | and |
| | | Good | Good | Good | Good | Good | and not | Good |
| | | | | | | | Good | |
| | Toner | Deposit- | No | No | No | Deposit- | Deposit- | No |
| | deposition in | ion | deposit- | deposit- | deposit- | ion | ion | deposit- |
| | endurance test | | ion | ion | ion | | | ion |
| | (10000 sheets) | | | | | | | |
| | Stain | Good | Good | Good | Good | Good | Good | Good |
| | resistance | | | | | | | |
| | Transfer | 95 | 96 | 96 | 96 | 96 | 90 or | 96 |
| | efficiency (%) | | | | | | less | |

### Examples 14 to 17 and Comparative Examples 8 and 9

Electroconductive endless belts according to Examples 14 to 17 and Comparative Examples 8 and 9 were prepared by the procedure of Examples 1 to 13, except for using materials having the compositions shown in Table 4 below. The properties of the prepared belts were determined by the following procedures. These results are also shown in Table 4.

<Measurement of Volume Resistivity>

The volume resistivity was measured at a measurement voltage of 500 V, a temperature of 23° C., and relative humidity of 50% using a sample chamber R12704A connected to a resistance meter R8340A (Advantest Corporation).

<Image Quality>

The above-prepared belts were mounted for a tandem image-forming apparatus shown in FIG. 2 using a transfer/transport belt, and an endurance test was performed in which transfer was repeatedly performed for 100,000 sheets of A-4 sized paper. Based on the results of this endurance test, the image quality, toner deposition in the endurance test, and stain resistance were evaluated.

TABLE 4

| | | Example | Example | Example | Example | Com. Ex. | Com. Ex. |
|---|---|---|---|---|---|---|---|
| | | 14 | 15 | 16 | 17 | 8 | 9 |
| Belt composition | PBN*¹² | 60 | 60 | 60 | 60 | 60 | 60 |
| | PET*¹³ | 40 | 40 | — | — | 40 | — |
| | PBT*¹⁴ | — | — | 40 | 40 | — | 40 |
| | Carbon | 12 | 12 | 15 | 15 | 12 | 15 |
| | black*¹⁵ | | | | | | |
| | PTFE | 0.5 | 2.5 | 0.5 | 2.5 | — | — |
| | Acrylic- | | | | | | |
| | modified | | | | | | |
| | PTFE*¹⁰ | | | | | | |
| | Molding | 270 | 270 | 270 | 270 | 270 | 270 |
| | temperature | | | | | | |
| | (° C.) | | | | | | |
| | Volume | 10.0 | 9.9 | 10.6 | 10.5 | 10.0 | 10.5 |
| | resistivity | | | | | | |
| | log R (500V) | | | | | | |
| | (Ω • cm) | | | | | | |
| | Image quality | Smooth | Smooth | Smooth | Smooth | Smooth | Smooth |
| | | and | and | and | and | and | and |
| | | Good | Good | Good | Good | Good | Good |
| | Toner | No | No | No | No | Slight | Slight |
| | deposition in | deposit- | deposit- | deposit- | deposit- | deposit- | deposit- |
| | endurance test | ion | ion | ion | ion | ion | ion |
| | (100000 sheets) | | | | | | |
| | Stain | Good | Good | Good | Good | Good | Good |
| | resistance | | | | | | |

*¹²PBN: TQB-OT (Teijin Chemicals Ltd.)
*¹³PET: SA 1206 having a melt flow rate (MFR) at 270° C. of 10 to 14 grams/10 minutes (UNITIKA LTD.)
*¹⁴PBT: 1401 CH2 having a melt flow rate (MFR) at 270° C. of 77 grams/10 minutes (Toray Industries, Ltd.)
*¹⁵Carbon black: Denka Black (Denki Kagaku Kogyo Kabushiki Kaisha)

Tables 1 to 4 demonstrate that the belts according to Example 14 to 17 are resistant to toner deposition in long-term repetitive use of belt (in the endurance test) and have excellent toner transfer efficiency in image output. These belts each contain a thermoplastic resin as a base resin and further contain an acrylic-modified PTFE and an electroconductive material. Accordingly, image-forming apparatuses using these belts can produce images with good quality while preventing failures even in long-term repetitive use.

### Examples 18 to 23 and Comparative Example 10

Electroconductive endless belts according to Examples 18 to 23 and Comparative Example 10 were prepared by the procedure of Examples 1 to 13, except for using materials having the compositions shown in Table 5 below. The properties of the prepared belts were determined by the following procedures. These results are also shown in Table 5.

<Measurement of Volume Resistivity>

The volume resistivity was measured at measurement voltages of 100 V and 500 V, a temperature of 23° C., and relative humidity of 50% using a sample chamber R12704A connected to a resistance meter R8340A (Advantest Corporation).

<Image Quality>

The belts thus formed were mounted for a tandem image-forming apparatus shown in FIG. 2 using a transfer/transport belt, and an endurance test was performed in which transfer was repeatedly performed for 100,000 sheets of A-4 sized paper. Based on the results of this endurance test, the image quality, toner deposition in the endurance test, and stain resistance were evaluated.

TABLE 5

| | | Example | Example | Example | Example | Example | Example | Com. Ex. |
|---|---|---|---|---|---|---|---|---|
| | | 18 | 19 | 20 | 21 | 22 | 23 | 10 |
| Belt composition | PBN*¹² | 95 | 55 | 95 | 55 | 55 | 55 | — |
| | PBT*¹⁴ | 5 | 45 | 5 | 45 | 45 | 45 | — |
| | PC*¹⁶ | — | — | — | — | — | — | 100 |
| | Carbon | 16 | 15 | 16 | 15 | 15 | 15 | — |
| | black*¹⁵ | | | | | | | |
| | FEF carbon | — | — | — | — | — | — | 30 |
| | Fluorocarbon | — | — | — | — | 5 | — | — |
| | polymer (A)*¹⁷ | | | | | | | |
| | Fluorocarbon | — | — | — | — | — | 5 | — |
| | polymer (B)*¹⁸ | | | | | | | |
| | Hydrolysis | — | — | 3 | 3 | — | — | — |
| | inhibitor*¹⁹ | | | | | | | |
| | PTFE | 1 | 1 | 1 | 1 | 1 | 1 | — |
| | Acrylic- | | | | | | | |
| | modified | | | | | | | |
| | PTFE*¹⁰ | | | | | | | |
| | Molding | 270 | 270 | 270 | 270 | 270 | 270 | 260 |
| | temperature (° C.) | | | | | | | |
| | Volume | — | — | — | — | — | — | 10.0 |
| | resistivity | | | | | | | |
| | log R (100 V) | | | | | | | |
| | (Ω • cm) | | | | | | | |
| | Volume | 10.5 | 10.4 | 10.5 | 10.4 | 10.3 | 10.3 | 6.5 or |
| | resistivity | | | | | | | less |
| | log R (500 V) | | | | | | | |
| | (Ω • cm) | | | | | | | |
| | Image quality | Smooth | Smooth | Smooth | Smooth | Smooth | Smooth | Poor |
| | | and | and | and | and | and | and | |
| | | Good | Good | Good | Good | Good | Good | |
| | Toner deposition | No | No | No | No | No | No | Unanal- |
| | in endurance | deposit- | deposit- | deposit- | deposit- | deposit- | deposit- | yzable |
| | test (10000 | ion | ion | ion | ion | ion | ion | |
| | sheets) | | | | | | | |
| | Stain resistance | Good | Good | Good | Good | Good | Good | Good |

*¹⁶PC: Panlite K-1300 (Teijin Chemicals Ltd.)
*¹⁷Polymeric ionic conductive agent A: Pelestat NC6321 (Sanyo Chemical Industries, Ltd.)
*¹⁸Polymeric ionic conductive agent B: Irgastat P22 (Ciba Specialty Chemicals Inc.)
*¹⁹Carbodiimide compound: CARBODILITE E PELLET (Nisshinbo Industries. Inc.)

### Examples 24 to 29 and Comparative Examples 11 to 16

Electroconductive endless belts according to Examples 24 to 29 and Comparative Examples 11 to 16 were prepared by the procedure of Examples 1 to 13, except for using materials having the compositions shown in Table 6 and 7 below. The properties of the prepared belts were determined by the following procedures. These results are also shown in Table 6 and 7.

<Measurement of Volume Resistivity>

The volume resistivity was measured at a measurement voltage of 500 V, a temperature of 23° C., and relative humidity of 50% using a sample chamber R12704A connected to a resistance meter R8340A (Advantest Corporation).

<Image Quality>

The belts thus formed were mounted for a tandem intermediate transfer image-forming apparatus shown in FIG. 4 using a tandem intermediate transfer belt (member), and an endurance test was performed in which transfer was repeatedly performed for 10,000 sheets of A-4 sized paper. Based on the results of this endurance test, the image quality, toner deposition in the endurance test, and stain resistance were evaluated.

<Transfer Efficiency>

The transfer efficiency was determined according to the following steps (1) to (3).

(1) The weight of belt (A1) and that of paper (B1) were measured before transfer step (2).

(2) The above-prepared belts were mounted for a tandem intermediate transfer image-forming apparatus as a tandem intermediate transfer belt (member) shown in FIG. 4, and a series of transfer procedures (image output) was conducted, and the weight of belt (A2) and that of paper (B2) were measured.

(3) The transfer efficiency was determined by calculation according to the following equation:
Transfer efficiency(%)=(B2−B1)/[(B2−B1)+(A2−A1)]×100

TABLE 6

| | | Example | Example | Example | Example | Example | Example |
|---|---|---|---|---|---|---|---|
| | | 24 | 25 | 26 | 27 | 28 | 29 |
| Belt composition | PBN*¹² | 60 | 40 | 40 | 40 | 35 | — |
| | PBT*¹⁴ | 30 | 30 | 30 | 30 | 10 | 40 |
| | PBN | 10 | 30 | 30 | 30 | 55 | — |
| | Elastomer*²⁰ | | | | | | |
| | PBT | — | — | — | — | — | 60 |
| | Elastomer*²¹ | | | | | | |
| | Carbon | 16 | 15 | 15 | 15 | 14 | 18 |
| | black*¹⁵ | | | | | | |
| | Polymeric | — | — | 0.5 | 2 | — | — |
| | ionic | | | | | | |
| | conductive | | | | | | |
| | agent A*¹⁷ | | | | | | |
| | Hydrolysis | 3 | 3 | 3 | 3 | — | — |
| | inhibitor*¹⁹ | | | | | | |
| | PTFE | 1 | 1 | 1 | 1 | 1 | 1 |
| | Acrylic- | | | | | | |
| | modified | | | | | | |
| | PTFE*¹⁰ | | | | | | |
| | Molding | 270 | 270 | 270 | 270 | 270 | 270 |
| | temperature | | | | | | |
| | (° C.) | | | | | | |
| | Volume | 8.2 | 8.7 | 8.7 | 8.6 | 8.8 | 10.2 |
| | resistivity | | | | | | |
| | log R (500V) | | | | | | |
| | (Ω • cm) | | | | | | |
| | Image quality | Smooth | Smooth | Smooth | Smooth | Smooth | Smooth |
| | | and | and | and | and | and | and |
| | | Good | Good | Good | Good | Good | Good |
| | Toner | No | No | No | No | No | No |
| | deposition in | deposit- | deposit- | deposit- | deposit- | deposit- | deposit- |
| | endurance test | ion | ion | ion | ion | ion | ion |
| | (10000 sheets) | | | | | | |
| | Stain | Good | Good | Good | Good | Good | Good |
| | resistance | | | | | | |
| | Transfer | 98 or | 98 or | 98 or | 98 or | 98 or | 98 or |
| | efficiency (%) | more | more | more | more | more | more |

*²⁰PBN Elastomer: PELPRENE EN-16000 having a crystalline melting point of 241° C. (Toyobo Co., Ltd.)
*²¹PBT Elastomer: PELPRENE E-450B having a crystalline melting point of 222° C. (Toyobo Co., Ltd.)

TABLE 7

| | | Com. | Com. | Com. | Com. | Com. | Com. |
|---|---|---|---|---|---|---|---|
| | | Ex. 11 | Ex. 12 | Ex. 13 | Ex. 14 | Ex. 15 | Ex. 16 |
| Belt composition | PBN*¹² | 60 | 40 | 40 | 40 | 35 | — |
| | PBT*¹⁴ | 30 | 30 | 30 | 30 | 10 | 40 |
| | PBN | | | | | | |
| | Elastomer*²⁰ | 10 | 30 | 30 | 30 | 55 | — |
| | PBT | — | — | — | — | — | 60 |
| | Elastomer*²¹ | | | | | | |
| | Carbon | 16 | 15 | 15 | 15 | 14 | 18 |
| | black*¹⁵ | | | | | | |
| | Polymeric | — | — | 0.5 | 2 | — | — |
| | ionic | | | | | | |
| | conductive | | | | | | |
| | agent A*¹⁷ | | | | | | |
| | Hydrolysis | 3 | 3 | 3 | 3 | 3 | — |
| | inhibitor*¹⁹ | | | | | | |
| | PTFE | — | — | — | — | — | — |
| | Acrylic | | | | | | |
| | modified | | | | | | |
| | PTFE*¹⁰ | | | | | | |
| | Molding | 270 | 270 | 270 | 270 | 270 | 270 |
| | temperature (° C.) | | | | | | |
| | Volume | | | | | | |
| | resistivity | | | | | | |
| | log R (500V) | 8.2 | 8.7 | 8.7 | 8.6 | 8.8 | 10.2 |
| | (Ω • cm) | | | | | | |
| | Image quality | Smooth | Smooth | Smooth | Smooth | Smooth | Smooth |
| | | and | and | and | and | and | and |
| | | Good | Good | Good | Good | Good | Good |
| | Toner | Slight | Slight | Slight | Slight | Slight | Slight |
| | deposition in | deposit- | deposit- | deposit- | deposit- | deposit- | deposit- |
| | endurance test | ion | ion | ion | ion | ion | ion |
| | (10000 sheets) | | | | | | |
| | Stain | Good | Good | Good | Good | Good | Good |
| | resistance | | | | | | |
| | Transfer | 96 | 96 | 97 | 97 | 97 | 96 |
| | efficiency (%) | | | | | | |

While preferred embodiments have been described, it should be understood by those skilled in the art that various modifications, combinations, subcombinations, and alterations may occur depending on design requirements and other factors insofar as they are within the scope of the appended claims or the equivalents thereof.

What is claimed is:

1. An electroconductive endless belt for use as an intermediate transfer member, the intermediate transfer member being disposed between an image-forming member and a recording medium and being configured to be circularly driven by a drive member, to temporarily hold toner images transferred from the surface of the image-forming member, and to transfer the toner images onto the recording medium, the electroconductive endless belt comprising:
a thermoplastic resin as a base resin;
an acrylic-modified polytetrafluoroethylene; and
an electroconductive material.

2. An electroconductive endless belt for a tandem transfer/transport system, the system being configured to allow the electroconductive endless belt to hold a recording medium using electrostatic attraction, to drive the belt circularly by the action of a drive member so as to transport the recording medium held by the belt to four different image-forming members, and to transfer respective toner images provided on the image-forming members sequentially onto the recording medium, the electroconductive endless belt comprising:
a thermoplastic resin as a base resin;
an acrylic-modified polytetrafluoroethylene; and
an electroconductive material.

3. An electroconductive endless belt for use as a tandem intermediate transfer member, the random intermediate transfer member being disposed between four different image-forming members and a recording medium and being configured to be circularly driven by a drive member, to temporarily hold toner images sequentially transferred from the image-forming members, and to transfer the toner images onto the recording medium, the electroconductive endless belt comprising:
a thermoplastic resin as a base resin;
an acrylic-modified polytetrafluoroethylene; and
an electroconductive material.

4. The electroconductive endless belt according to any one of claims 1 to 3,
wherein the thermoplastic resin comprises at least one selected from the group consisting of (a) a thermoplastic polyamide, (b) an acrylonitrile-butadiene-styrene resin, (c) a thermoplastic polyacetal, (d) a polymer alloy or a polymer blend containing at least two of the resins (a) to (c), and (e) a polymer alloy or a polymer blend containing at least one of the resins (a) to (c) and another thermoplastic resin, and
wherein the electroconductive material contains a polymeric ionic conductive agent.

5. The electroconductive endless belt according to claim 4, further comprising a fluorocarbon polymer.

6. The electroconductive endless belt according to any one of claims 1 to 3, wherein the thermoplastic resin comprises:
a thermoplastic polyester resin; and
a thermoplastic polyester elastomer.

7. The electroconductive endless belt according to any one of claims 1 to 3, wherein the thermoplastic resin comprises:
a thermoplastic poly(alkylene naphthalate); and
another thermoplastic resin having an ester bond than the thermoplastic poly(alkylene naphthalate).

8. The electroconductive endless belt according to claim 7,
wherein the thermoplastic resin having an ester bond has a melt flow rate (MFR) at 270° C. of 3 to 80 grams/10 minutes,
wherein the weight ratio of the thermoplastic poly(alkylene naphthalate) to the thermoplastic resin having an ester bond is within a range of 95:5 to 55:45, and
wherein the electroconductive material comprises a carbon black.

9. The electroconductive endless belt according to one of claim 7, wherein the thermoplastic poly(alkylene naphthalate) comprises at least one of a thermoplastic poly(butylene naphthalate) and a thermoplastic poly(ethylene naphthalate).

10. The electroconductive endless belt according to claim 7, wherein the thermoplastic resin having an ester bond comprises a thermoplastic poly(alkylene terephthalate).

11. The electroconductive endless belt according to claim 10, wherein the thermoplastic resin having an ester bond comprises a thermoplastic poly(ethylene terephthalate) having a melt flow rate (MFR) at 270° C. of 3 to 45 grams/10 minutes.

12. The electroconductive endless belt according to claim 10, wherein the thermoplastic resin having an ester bond comprises a thermoplastic poly(butylene terephthalate) having a melt flow rate (MFR) at 270° C. of 25 to 80 grams/10 minutes.

13. The electroconductive endless belt according to any one of claims 1 to 3, wherein the amount of the acrylic-modified polytetrafluoroethylene is 0.01 to 5 parts by weight relative to 100 parts by weight of the base resin component.

14. An image-forming apparatus comprising the electroconductive endless belt according to any one of claims 1 to 3.
